(19) United States
(12) Patent Application Publication
(10) Pub. No.: US 2009/0125373 A1
(43) Pub. Date: May 14, 2009

(54) DATA VALIDATION WITHIN MATERIALS REQUIREMENTS PLANNING

(75) Inventors: Richard J. Lukes, Denver, NC (US); Stephen T. McDonald, Staatsburg, NY (US); Michael T. Phelan, Milton, NY (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, Armonk, NY (US)

(21) Appl. No.: 11/937,055

(22) Filed: Nov. 8, 2007

(51) Int. Cl. G06Q 10/00

(52) U.S. Cl. 705/10

(57) ABSTRACT

A method and system for validating data and providing on-time updates within a multi-enterprise material requirements planning environment. A method of validating materials requirements planning (MRP) results includes determining when a current aggregate demand of a part number is greater than or less than a previous aggregate demand of the part number by a first predetermined tolerance. The method also includes identifying at least one driver of the part number in which a current demand is greater than or less than a previous demand by a second predetermined tolerance. Additionally, the method includes generating a report comprising the at least one driver, the current demand, and the previous demand.

### FIELD OF THE INVENTION

The present invention relates generally to materials requirements planning, and, more particularly, to validating data and providing on-time updates within a multi-enterprise material requirements planning environment.

### BACKGROUND OF THE INVENTION

In today's business environment, the manufacturing processes of products (e.g., computer products) are continually and rapidly evolving. A Materials Requirement Planning (MRP) tool is commonly used by a manufacturing enterprise for locating and gathering the required parts and/or components needed to build a desired end-product. For example, conventional MRP tools comprise software (e.g., database) based applications that determine demand for parts (e.g., via part numbers) based upon input data (e.g., known demand for end-products containing the parts, predicted demand for end-products containing the parts, inventory of the parts, etc.). As input data changes, the MRP tool is run (i.e., executed) in a periodic fashion (e.g., once every planning cycle (e.g., ten business days)) to provide a constantly-updated planning and inventory control system for the manufacturing processes.

Within conventional multi-enterprise MRP processes, in order to be market driven and maintain the ability to adjust to changes in demand and supply, it is advantageous when the planning cycles supporting the integrated supply chain have the capability to enable ever-shortening reduced cycle times within the overall process. One of the ways to shorten the cycle time is to shorten the validation steps of the MRP results.

More specifically, once MRP results are generated, it is common practice to perform a validation step for validating the Demand, as well as Bills of Materials, any engineering change activity and/or correction of the MRP data in order to produce a valid forecast. However, this validation activity generally requires extensive analysis and inventory corrections, which may ultimately result in missed planning and product-to-market opportunities, since updates and corrections cannot be made until the next MRP Planning Cycle run or rerun. As such, the conventional batch interface MRP driven applications are generally labor and system resource cumbersome, time consuming, expensive and inefficient, particularly when used for integrating an external supplier into an Inter-Enterprise MRP for fulfilling an order request and for timely validating the obtained results.

In some known environments, all analysis, validation, updates, and corrections of the MRP Planning Cycle run are made by a worldwide team of geographic validation team representatives, all within a predefined four hour window of opportunity. This is performed on such a short time period so that the output of the final MRP run can be used to adequately prepare the supply chain for execution in a timely manner. However, when the analysis, validation, updates, and/or corrections cannot be performed within this four hour window, there is strong potential for cycle delays, planning reruns, increased customer liability, missed shipments, shortfall of supply to meet demand, etc.

Accordingly, there exists a need in the art to overcome the deficiencies and limitations described hereinabove.

### SUMMARY OF THE INVENTION

In a first aspect of the invention, there is a method of validating materials requirements planning (MRP) results includes determining when a current aggregate demand of a part number is greater than or less than a previous aggregate demand of the part number by a first predetermined tolerance. The method also includes identifying at least one driver of the part number in which a current demand is greater than or less than a previous demand by a second predetermined tolerance. Additionally, the method includes generating a report comprising the at least one driver, the current demand, and the previous demand.

In another aspect of the invention, there is a system for validating materials requirements planning (MRP) results. The system includes a computer infrastructure configured to determine when a current aggregate demand of a part number is greater than or less than a previous aggregate demand of the part number by a first predetermined tolerance. The computer infrastructure is further operable to identify at least one driver of the part number in which a current demand is greater than or less than a previous demand by a second predetermined tolerance.

In another aspect of the invention, there is a computer program product comprising a computer usable medium having a computer readable program embodied in the medium. The computer readable program when executed on a computing device is operable to cause the computing device to: identify at least one driver of a part number in which a current demand of the at least one driver is greater than or less than a previous demand of the at least one driver by a predetermined tolerance; and generate a report comprising: the at least one driver, the current demand, the previous demand, and a plurality of historical demands associated with a plurality of previous MRP planning cycles.

### BRIEF DESCRIPTION OF THE DRAWINGS

The present invention is described in the detailed description which follows, in reference to the noted plurality of drawings by way of non-limiting examples of exemplary embodiments of the present invention, in which:

FIG. 1 shows an illustrative environment for implementing the steps in accordance with the invention;

FIG. 2 shows an exemplary exploded bill of material according to aspects of the invention;

FIG. 3 shows an exemplary historical trend forecast demand and shipment report according to aspects of the invention; and

FIGS. 4A-4D show flow diagrams depicting implementations of methods according to aspects of the invention.

### DETAILED DESCRIPTION OF EMBODIMENTS OF THE INVENTION

The present invention relates generally to materials requirements planning, and, more particularly, to validating data and providing on-time updates within a multi-enterprise material requirements planning (MRP) environment. Implementations of the invention provide a system and method for identifying errors in parts requirements forecasts and acting on those errors in a shortened time period. More specifically, embodiments of the invention include an enhanced reporting tool and validation process that are used to make updates/changes in a timely manner within an MRP run cycle. The validation process provides quick identification and updating (e.g., correcting) of errors and anomalies in source records, demand forecasts, and inventory records. In this manner, an updated and validated final MRP run is provided within a tightly constrained cycle time period.

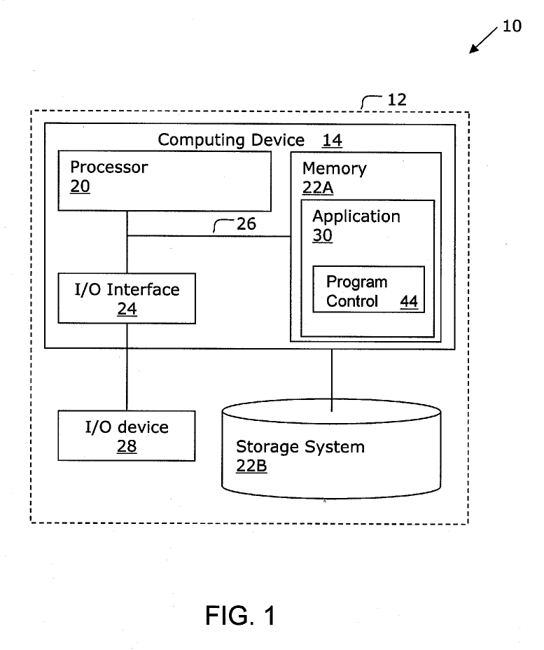

FIG. 1 shows an illustrative environment 10 for managing the processes in accordance with the invention. To this extent, the environment 10 includes a computer infrastructure 12 that can perform the processes described herein. In particular, the computer infrastructure 12 includes a computing device 14 that comprises an application 30 having a program control 44, which makes the computing device 14 operable to perform the processes described herein, such as, for example, creating an enhanced report and/or validating an MRP run. The computing device 14 includes a processor 20, a memory 22A, an input/output (I/O) interface 24, and a bus 26. The memory 22A can include local memory employed during actual execution of program code, bulk storage, and cache memories which provide temporary storage of at least some program code (e.g., program control 44) in order to reduce the number of times code must be retrieved from bulk storage during execution. Further, the computing device 14 is in communication with an external I/O device/resource 28 and a storage system 22B. The I/O device 28 can comprise any device that enables an individual to interact with the computing device 14 or any device that enables the computing device 14 to communicate with one or more other computing devices using any type of communications link. The external I/O device/resource 28 may be keyboards, displays, pointing devices, etc.

The processor 20 executes computer program code (e.g., program control 44), which is stored in memory 22A and/or storage system 22B. While executing computer program code, the processor 20 can read and/or write data to/from memory 22A, storage system 22B, and/or I/O interface 24. The bus 26 provides a communications link between each of the components in the computing device 14.

The computing device 14 can comprise any general purpose computing article of manufacture capable of executing computer program code installed thereon (e.g., a personal computer, server, wireless notebook, smart phone, personal digital assistant, etc.). However, it is understood that the computing device 14 is only representative of various possible equivalent computing devices that may perform the processes described herein. To this extent, in embodiments, the functionality provided by the computing device 14 can be implemented by a computing article of manufacture that includes any combination of general and/or specific purpose hardware and/or computer program code. In each embodiment, the program code and hardware can be created using standard programming and engineering techniques, respectively.

Similarly, the computer infrastructure 12 is only illustrative of various types of computer infrastructures for implementing the invention. For example, in embodiments, the computer infrastructure 12 comprises two or more computing devices (e.g., a server cluster) that communicate over any type of communications link, such as a network, a shared memory, or the like, to perform the processes described herein. Further, while performing the processes described herein, one or more computing devices in the computer infrastructure 12 can communicate with one or more other computing devices external to the computer infrastructure 12 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

In embodiments, the invention provides a business method that performs the steps of the invention on a subscription, advertising, and/or fee basis. That is, a service provider, such as a Solution Integrator or providing entity, could offer to perform the processes described herein. In this case, the service provider can create, maintain, deploy, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

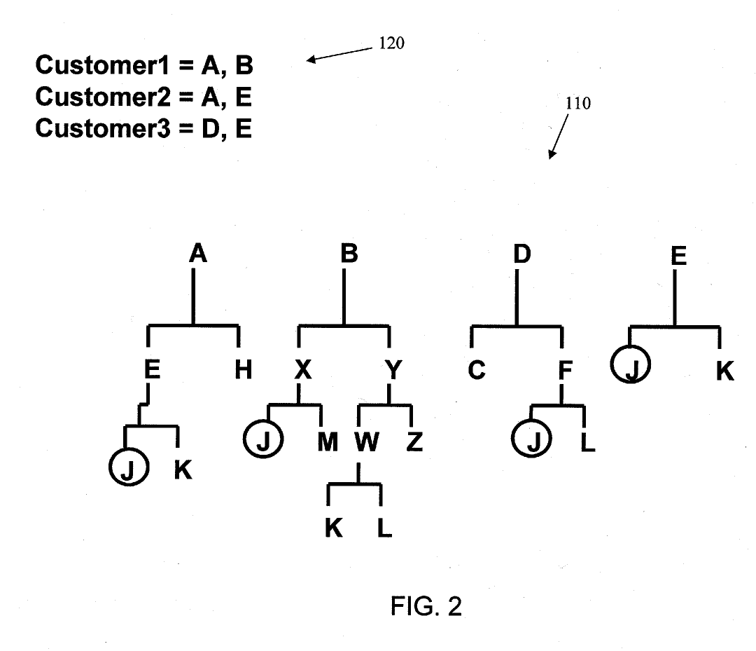

FIG. 2 shows an exemplary exploded bill of materials (BOM) for various end-products that may be used, for example, with an MRP tool in a planning cycle. For example, the product structure area 110 shows that end-product “A” contains subassembly “E” and part number “H”, where subassembly “E” is further defined to include part numbers “J” and “K”. Similarly, it can be seen that product “B” includes subassemblies “X” and “Y”, where subassembly “X” includes part numbers “J” and “M”. Also, product “D” includes part number “C” and subassembly “F”, where subassembly “F” includes part numbers “J” and “L”. Lastly, product “E” includes part numbers “J” and “X”. Thus, the exploded-BOM view depicted in FIG. 2 shows how different end products may be made up of various subassemblies and/or individual part numbers. Also, the invention is not limited to use with subassemblies and part numbers; rather, the implementations of the invention may be used with any desired manufacturing process environment. Moreover, a bill of materials may be much more complex than that shown in FIG. 2 (for example, having over one hundred levels), and the invention is not limited to the simple BOMs shown in FIG. 2.

FIG. 2 also shows in forecast demand area 120 that Customer1 has an order for one unit each of product “A” and “B”, Customer2 has an order for one unit each of products “A” and “E”, and Customer3 has an order for one unit each of products “D” and “E”. Based upon these three orders, there is a total demand for six units of part number “J”. This demand is referred to as an aggregate demand since it takes into account all of the possible demand sources for the part number. As is known in the art, such that further explanation is not believed necessary, such information is useful for planning the manufacturing processes of the end-products.

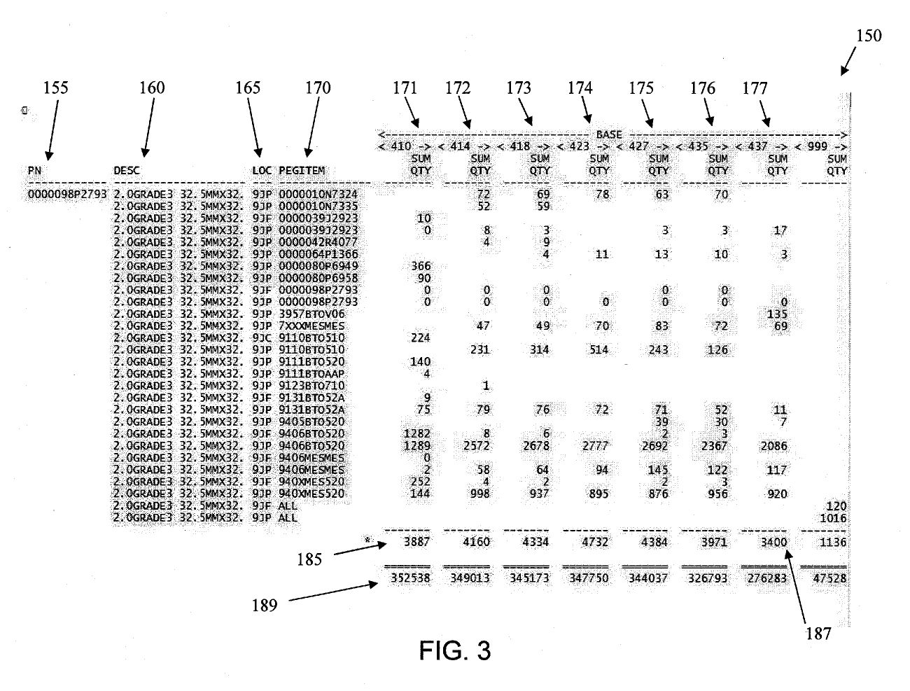

FIG. 3 shows an exemplary historical trend forecast demand and shipment report 150 according to aspects of the invention. The report 150 and improved validation process (described below) allow users to quickly and efficiently identify and correct errors in the MRP cycle results. In embodiments, the report is generated for each part number that has a aggregate demand in the current MRP cycle that differs from the aggregate demand of the part number from a previous MRP cycle by more than a predetermined threshold. In this manner, anomalies that arise from incorrect (e.g., erroneous) input data to the MRP tool may be quickly identified and rectified.

In the exemplary report 150 depicted in FIG. 3, a part number 155, part number description 160, part number location 165, and pegitem (e.g., pegged box assembly or product) 170 are displayed. Each horizontal row of the report 150 that contains a description 160, location 165, and pegitem 170 corresponds to a “driver” for that part number, which represents a particular demand for a quantity of the part number. For example, referring back to FIG. 2, Customer1's order of one unit of end-product “A” corresponds to a single driver for part “J”.

Still referring to FIG. 3, columns 171, 172, 173, 174, 175, and 176 represent MRP results from previous cycles. For example, column 171 contains data (e.g., demand quantity) associated with the MRP run for cycle “410,” and shows that a quantity of 10 units of part number 0000098P2793 were forecast as demand for pegitem 0000039J2923 at cycle “410.” The data populating columns 171-176 includes data that is generated and stored during previous MRP cycle runs, and is accessible, for example, via database operations.

Column 177 shows the demand for each driver of the part number (e.g., 0000098P2793) in the current MRP cycle. The values populating column 177 are obtained using input data and a conventional MRP tool. By displaying the current demand for each driver adjacent the historic demand for the same driver, a user may quickly and efficiently identify those drivers that warrant further examination as to possibly adversely affecting the aggregate demand of the part number. For example, as described in greater detail below, a driver whose current demand differs from the historical demand by a predetermined threshold may adversely affect the aggregate demand of the part number.

Still referring to FIG. 3, row 185 represents the aggregate demand for the part number (e.g., 0000098P2793) for each cycle, and the values in row 185 equal the sum of the demand of the drivers for each respective cycle. For example, in cycle “437”, the aggregate demand for the part number (e.g., 0000098P2793) is 3400 units, as represented by reference character 187. Additionally, row 189 contains values representing the total demand for all part numbers supplied by a particular supplier for any given cycle. In embodiments, these values may also be used for detecting anomalies in MRP cycle results.

### PROCESSES OF THE INVENTION

The steps of the flow diagrams described herein may be implemented in the environment of FIG. 1. The flow diagrams may equally represent a high-level block diagram of the invention. The steps of the flow diagrams may be implemented and executed from a server, in a client-server relationship, or they may run on a user workstation with operative information conveyed to the user workstation. Additionally, the invention can take the form of an entirely hardware embodiment, an entirely software embodiment or an embodiment containing both hardware and software elements. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

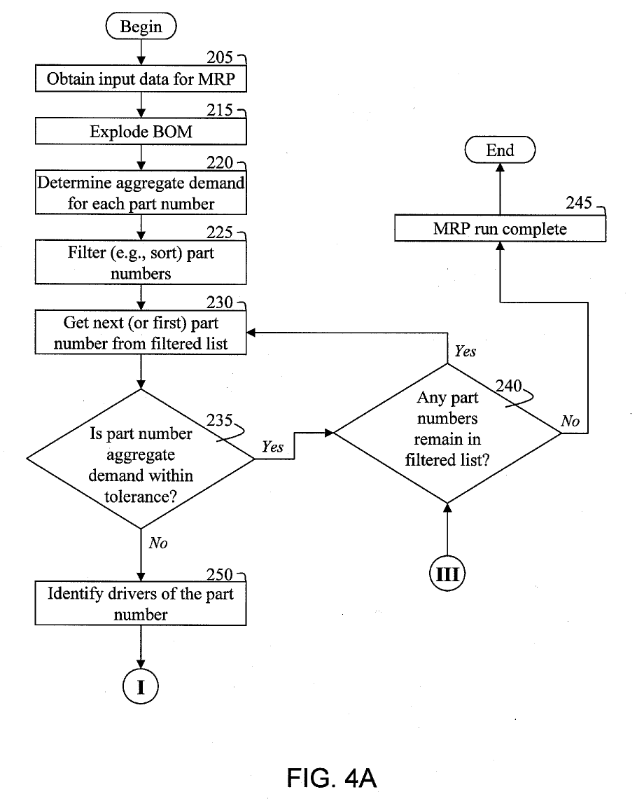

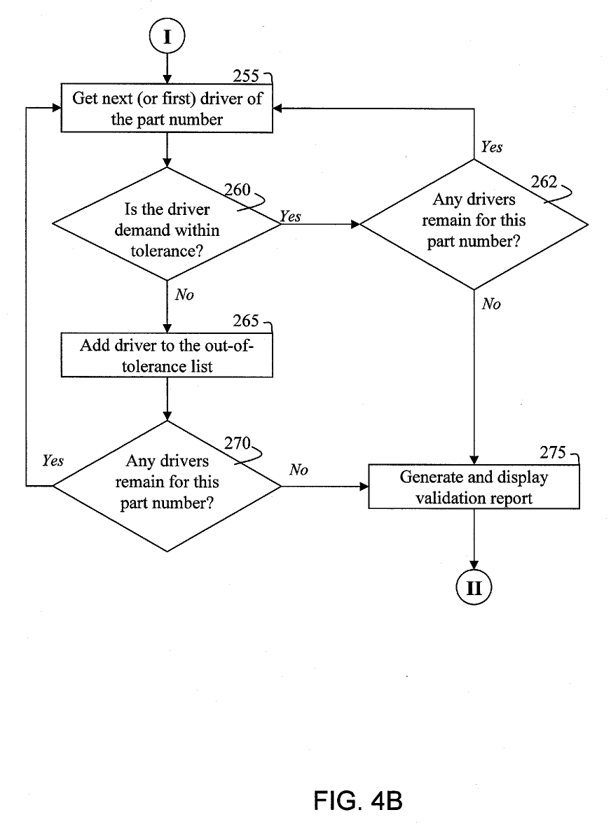

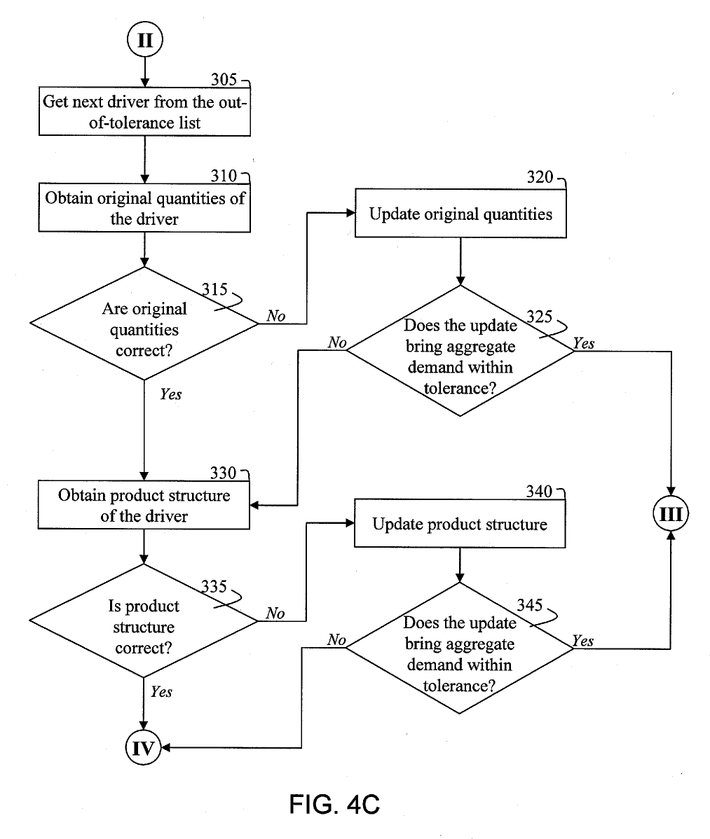

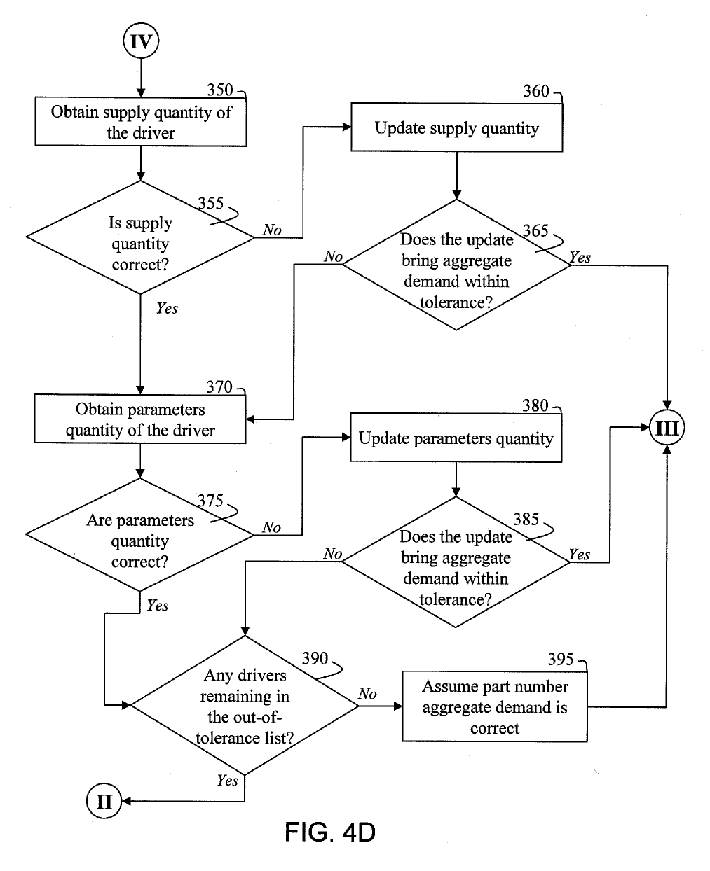

FIG. 4A shows a flow diagram depicting steps of a first method according to aspects of the invention. At step 205, data that is used as the input for an MRP tool is obtained. In embodiments, the obtained data includes, but is not limited to, existing customer orders for an end-products and/or subassemblies, forecast customer orders for end-products and/or subassemblies, etc. Such data may be obtained in any suitable conventional manner, such as, for example, by gathering customer order data from a database and/or using historical data to predict future customer orders. In implementations, the data obtained in step 205 is associated with a bill of material (BOM) that identifies part numbers and/or subassemblies of part numbers associated with the product(s). In embodiments, the data is stored in at least one database that is accessible by the MRP tool.

Step 215 includes generating an exploded bill of material (BOM) product structure (e.g., similar to that shown in FIG. 2) based upon the data gathered in step 205. In embodiments, this comprises identifying all of the individual part numbers of the individual components that make up end-products and/or subassemblies identified in step 205. In this manner, an aggregate demand is determined for each part number at step 220. Similar to the descriptions of FIGS. 2 and 3 above, the aggregate demand represents a total quantity of each part number that is required for this MRP cycle, and may be determined using a conventional MRP tool.

At step 225, the part numbers and associated aggregate demand values are filtered (e.g., sorted). In embodiments, this includes filtering all of the part numbers of step 220 in a sort order. The filtering may be based upon, for example, cost per unit, time to receive shipment of units, number of units required, or any other suitable parameter. The filtering may be performed using a database in the environment of FIG. 1. Steps 205-225 collectively constitute determining MRP results for a planning cycle. Methods for performing such steps are known, such that further explanation is not believed necessary, and may be performed in any suitable manner, such as, for example, utilizing a conventional MRP tool.

Validation of the determined MRP results begins at step 230, in which the next part number from the filtered list (from step 225) is obtained. During the first iteration, the next part number is the first part number of the filtered list. At step 235, the program control determines whether the aggregate demand of this part number (for this MRP cycle) is within a predefined tolerance of the aggregate demand of the same part number for a previous MRP cycle. The tolerance may be for example, 10%, although the invention is not limited to this value and any suitable tolerance value may be used with the invention. The previous aggregate demand for the part number is a value that was determined during the previous MRP cycle run (e.g., ten business days earlier), or may alternatively be an average from plural (e.g., six) previous MRP cycles.

At step 235, if the current aggregate demand for the part number is not greater than or less than the previous aggregate demand by the predefined tolerance, then that part number is deemed within tolerance (e.g., does not have an anomaly), and the process proceeds to step 240. At step 240, the program control determines whether there are any remaining part numbers in the filtered list. If there are remaining part numbers, then the process returns to step 230 to examine the aggregate demand of the next part number. However, if there are no further part numbers, then the process proceeds to step 245, where the MRP results for this cycle are deemed valid and the process ends.

However, if at step 235 the current aggregate demand for the part number is outside of the acceptable tolerance, then that part number is considered to have an error in its MRP results. At step 250, an enhanced validation process begins by identifying the all of the individual drivers of the part number. In embodiments, this is accomplished by using appropriate programming (e.g., scripts) to operate on and extract the pertinent driver data from the data obtained and determined in steps 205-225.

The process continues as shown in FIG. 4B at step 255 (where reference numeral “I” represents a connection between steps 250 and 255), in which data associated with the next (or first) driver of the drivers identified at step 250 is obtained by the program control. In embodiments, this data includes the description, location, pegitem, and demand for the particular driver, and may be similar, for example, to the data shown in FIG. 3. However, the invention is not limited to this data associated with the drivers, and any suitable data may be used with the invention.

At step 260 it is determined (for example, manually and/or via the program control) whether the current demand of this driver is within a predefined tolerance of a previous demand for this same driver from a previous MRP cycle. The determination at step 260 may be performed similarly to that of step 235, except that in step 260 the demand quantity of an individual driver of a part number is examined (instead of the aggregate demand for the part number (including all drivers), as at step 235). As with step 235, any suitable tolerance (e.g., 10%) may be used with the invention. Moreover, the tolerance used at step 260 may be different from, or the same as, that used at step 230.

If the demand for the particular driver is within tolerance at step 260, then that driver is deemed within tolerance and a determination is made as to whether there are any remaining drivers for this part number at step 262. If the part number has other drivers, the process returns to step 255 to obtain and examine the next driver of this part number. If there are no other drivers at step 262, then the process proceeds to step 275, described in greater detail below.

However, if the demand for the driver is outside of tolerance at step 260, then at step 265 that driver is noted (e.g., stored) in a list of out-of-tolerance drivers for this part number. At step 270, the program control determines whether any drivers remain for this part number. If drivers remain, then the process returns to step 255 to begin examination of the next driver.

However, if no drivers remain for this part number, then the process proceeds to step 275, where the list of out-of-tolerance drivers is finalized and output, such as, for example, in the form of a report as depicted in FIG. 3. That is, the out of tolerance drivers (from step 265) are listed on horizontal rows, and the historic and current demand for each driver is listed in vertical columns. The output may be in the form of at least one of: a computer display, printed copy, and electronically stored copy.

The process continues as shown in FIG. 4C (where reference numeral “II” represents a connection between steps 275 and 305). Beginning at step 305, each out of tolerance driver (from the list generated at step 275) is systematically examined, and possibly changed (e.g., the value of a data field of a database may be altered to a different value), until the aggregate demand for the particular part number is either within tolerance or assumed to be correct. In embodiments, this is accomplished by examining the data associated with each driver, and correcting (e.g., altering) the data as errors are found.

For example, at step 305, the next driver form the list of out-of-tolerance drivers is identified. During the first iteration, the next driver is the first driver of the list of out-of-tolerance drivers. At step 310 the “original quantities” of this particular driver are obtained. In embodiments, the original quantities comprises data such as, for example: the quantity of demand from a customer order, the quantity of forecast demand, etc. As is known in the art, these attributes are stored as values in data fields of a database that is used by the MRP tool to generate part number demand values (e.g., aggregate demand) for the cycle. Therefore, if any of these original quantities are inaccurate (either by typographical error, outdated information, etc.), this could cause the aggregate demand of the part number to be inaccurate (e.g., out of tolerance).

At step 315, it is determined whether the original quantities of the particular driver are accurate. The determination of step 315 may be performed manually, such as, for example, a user visually inspecting the data field(s) of the database where the original quantities are stored, and verifying whether the value stored in the database is accurate.

If, at step 315, the original quantities are accurate (i.e., there is no error in the original quantities data), then the process proceeds to step 330, which is described in greater detail below. However, if the original quantities are determined as inaccurate at step 315, then at step 320 the erroneous original quantities are updated. In embodiments, this is performed manually by a user changing the value of an appropriate data field (or data fields) in the database used by the MRP tool.

Then, at step 325, it is determined whether the update at step 320 is sufficient to bring the aggregate demand for the part number within tolerance. For example, the MRP tool may be rerun (e.g., similar to step 235) using the updated values of the original quantities (from step 320). If the aggregate demand is found to be within tolerance, then the part number as a whole is deemed within tolerance, and the process proceeds to step 240 (as indicated by connector “III”), where it is determined if another part number remains to be examined.

However, if the aggregate demand for the part number remains out of tolerance at step 325, then the process proceeds to step 330, where the next parameter of the driver is examined for errors. More specifically, at step 330, the “product structure” data of this particular driver are obtained. In embodiments, the product structure comprises data such as, for example: a part number of the part, a lead time for obtaining the part from a supplier, a subassembly in which the part is contained, a date the part is effective, a number of units per subassembly, etc. As is known in the art, these attributes are stored as values in data fields of a database that is used by the MRP tool to generate part number demand values (e.g., aggregate demand) for the cycle. Thus, if any of this product structure data is inaccurate (either by typographical error, outdated information, etc.), this could cause the aggregate demand of the part number to be inaccurate (e.g., out of tolerance).

At step 335, it is determined whether the product structure of the particular driver is accurate. The determination of step 335 may be performed manually, such as, for example, a user visually inspecting the data field(s) of the database where the product structure is stored, and verifying whether the value stored in the database is accurate.

If, at step 335, the product structure is accurate (i.e., there is no error in the product structure data), then the process proceeds to step 350, which is described in greater detail below with reference to FIG. 4D.

However, if the product structure is determined as inaccurate at step 335, then at step 340 the erroneous product structure is updated. In embodiments, this is performed manually by a user changing the value of an appropriate data field (or data fields) in the database used by the MRP tool.

Then, at step 345, it is determined whether the update at step 340 is sufficient to bring the aggregate demand for the part number within tolerance. For example, the MRP tool may be rerun (e.g., similar to step 235) using the updated values of the product structure (from step 340). If the aggregate demand is found to be within tolerance, then the part number as a whole is deemed within tolerance, and the process proceeds to step 240 (as indicated by connector “III”), where it is determined if another part number remains to be examined.

However, if the aggregate demand for the part number remains out of tolerance at step 345, then the process proceeds to step 350 (as indicated by connector “IV”), shown in FIG. 4D, where the next parameter of the driver is examined for errors. More specifically, at step 350 the “supply quantity” for the driver is obtained. In embodiments, the supply quantity comprises data such as, for example: the amount of inventory of the part number on hand, the amount of inventory that is expected to be delivered within a time period, etc. As is known in the art, these attributes are stored as values in data fields of a database that is used by the MRP tool to generate part number demand values (e.g., aggregate demand) for the cycle. Therefore, if any of the supply quantity is inaccurate (either by typographical error, outdated information, etc.), this could cause the aggregate demand of the part number to be inaccurate (e.g., out of tolerance).

At step 355, it is determined whether the supply quantity of the particular driver is accurate. The determination of step 355 may be performed manually, such as, for example, a user visually inspecting the data field(s) of the database where the supply quantity is stored, and verifying whether the value stored in the database is accurate.

If, at step 355, the supply quantity is accurate (i.e., there is no error in the original quantities data), then the process proceeds to step 370, which is described in greater detail below.

However, if the supply quantity is determined as inaccurate at step 355, then at step 360 the erroneous supply quantity is updated. In embodiments, this is performed manually by a user changing the value of an appropriate data field (or data fields) in the database used by the MRP tool.

Then, at step 365, it is determined whether the update at step 360 is sufficient to bring the aggregate demand for the part number within tolerance. For example, the MRP tool may be rerun (e.g., similar to step 235) using the updated values of the supply quantity (from step 360). If the aggregate demand is found to be within tolerance, then the part number as a whole is deemed within tolerance, and the process proceeds to step 240 (as indicated by connector “III”), where it is determined if another part number remains to be examined.

However, if the aggregate demand for the part number remains out of tolerance at step 365, then the process proceeds to step 370, where the next parameter of the driver is examined for errors. More specifically, at step 370 the “parameters quantity” for the driver is obtained. In embodiments, the parameters quantity comprises data such as, for example: safety stock, protective scheduling, frozen zones, etc., which are understood in the art such that further explanation is not believed necessary. As is known in the art, these attributes are stored as values in data fields of a database that is used by the MRP tool to generate part number demand values (e.g., aggregate demand) for the cycle. Therefore, if any of the parameters quantity is inaccurate (either by typographical error, outdated information, etc.), this could cause the aggregate demand of the part number to be inaccurate (e.g., out of tolerance).

At step 375, it is determined whether the parameters quantity of the particular driver is accurate. The determination of step 375 may be performed manually, such as, for example, a user visually inspecting the data field of the database where the parameters quantity is stored, and verifying whether the value stored in the database is accurate.

If, at step 375, the parameters quantity is accurate (i.e., there is no error in the parameters quantity data), then the process proceeds to step 390, which is described in greater detail below. However, if the parameters quantity is determined as inaccurate at step 375, then at step 380 the erroneous parameters quantity is updated. In embodiments, this is performed manually by a user changing the value of an appropriate data field (or data fields) in the database used by the MRP tool.

Then, at step 385, it is determined (for example, manually or via the program control) whether the update at step 380 is sufficient to bring the aggregate demand for the part number within tolerance. For example, the MRP tool may be rerun (e.g., similar to step 235) using the updated values of the parameters quantity (from step 380). If the aggregate demand is found to be within tolerance, then the part number as a whole is deemed within tolerance, and the process proceeds to step 240 (as indicated by connector “III”), where it is determined if another part number remains to be examined.

However, if the aggregate demand for the part number remains out of tolerance at step 385, this signifies that the particular driver just examined in steps 305-385 is not causing the part number aggregate demand to be out of tolerance. As such, another driver for the part number should be examined to determine whether it is driving the aggregate demand for the part number out of tolerance. Accordingly, at step 390, the program control determines whether there are any remaining drivers in the list of out of tolerance drivers (from step 275) for this part number. If there are remaining drivers, then the process returns to step 305 (as indicated by connector “II”), where the next driver is obtained and subsequently validated. In this manner, any out of tolerance drivers are examined, and possibly updated, until the aggregate demand for the part number is either brought within tolerance or all of the drivers have been corrected.

However, if there are no remaining drivers in the out-of-tolerance list of the part number, then the part number aggregate demand is deemed correct, and the process returns to step 240 (as indicated by connector “III”), to determine whether any part numbers remain to be validated. In this manner, all part numbers can examined for errors and anomalies in input data (e.g., source records, demand forecast, inventory records, etc.) such that an updated and validated final MRP run is provided within a tightly constrained cycle time period.

While the invention has been described in terms of embodiments, those skilled in the art will recognize that the invention can be practiced with modifications and in the spirit and scope of the appended claims.

What is claimed is:

1. A method of validating materials requirements planning (MRP) results, comprising:
determining when a current aggregate demand of a part number is greater than or less than a previous aggregate demand of the part number by a first predetermined tolerance;
identifying at least one driver of the part number in which a current demand is greater than or less than a previous demand by a second predetermined tolerance; and
generating a report comprising the at least one driver, the current demand, and the previous demand.

2. The method of claim 1, further comprising determining whether a parameter of the at least one driver is accurate or inaccurate.

3. The method of claim 2, wherein the parameter comprises at least one of: original quantities, product structure, supply quantity, and parameters quantity.

4. The method of claim 2, further comprising updating the parameter when the parameter is inaccurate.

5. The method of claim 4, wherein the updating comprises changing a value of a data field in a database.

6. The method of claim 4, further comprising determining whether the updating brings the current aggregate demand of the part number within tolerance.

7. The method of claim 1, wherein the first predetermined tolerance equals the second predetermined tolerance.

8. The method of claim 1, wherein the first predetermined tolerance does not equal the second predetermined tolerance.

9. The method of claim 1, wherein the previous demand equals a demand value of the at least one driver from a previous MRP planning cycle.

10. The method of claim 1, wherein the previous demand equals an average demand value of the at least one driver from a plurality of previous MRP planning cycles.

11. The method of claim 1, further comprising displaying the report.

12. The method of claim 11, wherein the report comprises historical demand values of the at least one driver for a plurality of previous MRP planning cycles.

13. The method of claim 1, wherein the at least one driver comprises a plurality of out of tolerance drivers of the part number.

14. The method of claim 1, wherein a service provider at least one of creates, maintains, deploys and supports a computer infrastructure that performs at least one of the identifying and the generating.

15. A system for validating materials requirements planning (MRP) results, comprising:
a computer infrastructure configured to:
determine when a current aggregate demand of a part number is greater than or less than a previous aggregate demand of the part number by a first predetermined tolerance; and
identify at least one driver of the part number in which a current demand is greater than or less than a previous demand by a second predetermined tolerance.

16. The system of claim 15, wherein the computer infrastructure is further configured to generate a report comprising the at least one driver, the current demand, and the previous demand.

17. The system of claim 15, wherein the computer infrastructure is further configured to determine whether an updating of at least one parameter of the at least one driver brings the current aggregate demand of the part number within tolerance.

18. The system of claim 17, wherein the at least one parameter comprises at least one of: original quantities, product structure, supply quantity, and parameters quantity.

19. A computer program product comprising a computer usable medium having a computer readable program embodied in the medium, wherein the computer readable program when executed on a computing device is operable to cause the computing device to:
identify at least one driver of a part number in which a current demand of the at least one driver is greater than or less than a previous demand of the at least one driver by a predetermined tolerance; and
generate a report comprising: the at least one driver, the current demand, the previous demand, and a plurality of historical demands associated with a plurality of previous MRP planning cycles.

20. The computer program product of claim 19, wherein:
the at least one driver comprises a plurality of out of tolerance drivers of the part number, and
the computer readable program is further operable to cause the computing device to display the report.
